(19) United States
(12) Patent Application Publication
(10) Pub. No.: US 2007/0156847 A1
(43) Pub. Date: Jul. 5, 2007

(54) System, receiver, method, and program for distribution content

(75) Inventor: Winfried Antonius Henricus Berkvens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,969

(22) PCT Filed: Feb. 8, 2005
(86) PCT No.: PCT/IB05/50498

§ 371 Date: Aug. 15, 2006

(30) Foreign Application Priority Data
Feb. 17, 2004 (EP) 04100630.5

(51) Int. Cl. G06F 15/16

(52) U.S. Cl. 709/219

(57) ABSTRACT

A system (100) for distributing a content (101) has a distributor (103) of the content (101) and a receiver (102) for receiving the content (101) from the distributor (103). The receiver (102) has a selector (104) for selecting a distributor (103) from a plurality of distributors, content-requesting means (105) for requesting the content (101) from the selected distributor (103), receiving means (106) for receiving the content (101), identity-determining means (107) for determining an identity (108) associated with the content (101), and a verifier (109) for verifying an availability of the content (101) at the distributor (103) on the basis of the determined identity (108). The distributor (103) of the content (101) has content request-receiving means (110) for receiving a request for the content (101), and a dispatcher (111) for dispatching the content (101). The distributor (103) is arranged to dispatch the content (101) to the receiver (102) in response to receiving a request for the content (101) from the receiver (102). The receiver (102) is arranged to only select the distributor (103) if the verifier (109) verified the availability of the content (101) at the distributor (103).

The invention relates to a system for distributing a content.

The invention also relates to a receiver, a method and a computer program product for use in such a system.

A system as described in the opening paragraph is known from WO 01/91417A2. This document discloses a streaming media delivery system which employs multiple client data networks storing copies of the streaming media, for distributing a content to a large number of users. When a viewer wishes to see content, the system chooses a client data network which is best for providing the media content and directs a client wrapper object on the viewer's system to this network. When the quality of delivery from this network becomes too low, a client wrapper object on the viewer's system can request a switchover to a new client data network. The system may also redirect the wrapper object to receive content from a different network for maintenance purposes and the like. The viewer wrapper object also provides monitoring information on communication line quality and the like to the system for feedback and logging purposes.

It is a drawback of the known system that a redirection server and a monitoring server are required. This increases the complexity and the cost of the system. Moreover, the system can no longer select a client data network which is best for providing the media content, if either the redirection server or the monitoring server malfunctions, or if connectivity is lost to these servers.

It is an object of the invention to provide a system of the type described in the opening paragraph, which is able to distribute the content to the receiver in a relatively simple, reliable and cheap manner.

The object is realized in that the system comprises:
a receiver for receiving the content, the receiver comprising:
   a selector for selecting a distributor of the content out of a plurality of distributors;
   content-requesting means for requesting the content from the distributor selected;
   receiving means for receiving the content;
   identity-determining means for determining an identity associated with the content; and
   a verifier for verifying an availability of the content at the distributor based on the identity determined,
the distributor of the content, comprising:
   content request-receiving means for receiving a request for the content; and
   a dispatcher for dispatching the content,
      wherein the distributor is arranged to dispatch the content to the receiver in response to receiving a request for the content from the receiver, and wherein the receiver is arranged to only select the distributor if the verifier verified the availability of the content at the distributor.

By having the availability of the content at the distributor verified before selecting the distributor, the reliability of the system is increased as it is ensured that the content is available at the distributor where the content is requested. The verification does not require an additional server, because the receiver is in charge of the verification.

The invention is based on the recognition that the receiver is in a relatively good position to select the distributor from which to obtain the content, and that verifying an availability of the content at the distributor increases the reliability of selecting a suitable distributor.

The system may comprise a network with a receiver with a processor for processing or rendering the content for presentation to a user of the receiver. The system may comprise the Internet, a worldwide web, an infrastructure with a client-server architecture, a server, a head-end, a set-top box, a network of web services, or a network using a Digital Video Broadcasting (DVB) standard.

The content may be, for example, news, a movie, an audio track, a still picture, a web page, a multimedia message, a webcast, or an on-line multimedia event or experience. The content may be distributed in a format such as e.g. a DVB stream, an MPEG stream, a stream of packets, a download file, or a physical medium. The content may be distributed with an energy pattern traveling via a physical medium, e.g. the air, a set of conductors, or a guide for electromagnetic energy such as an optical fiber or a waveguide. The content may alternatively be stored on a carrier and distributed by distribution of the carrier. Examples are mass-storage media, e.g. an optical disc such as CD, DVD, HD-DVD, or Blu-Ray.

The distribution may involve sampling the content, digitizing the content, source-coding the content, channel-coding the content, or decoding the content. Instead of sampling the content, it may be synthesized or generated with a computer. The content may be produced or stored at the distributor or alternatively at a content provider providing the content to the distributor.

The system comprises a receiver for receiving the content, and a distributor of the content. The receiver may be e.g. a device owned by an end-user. It may be, for example, a personal computer, or consumer electronics like a television set, an audio receiving set, a set-top box, a jukebox, a media player, a smartphone, or a home cinema system. The distributor may be owned e.g. by an access provider, a service provider, an aggregator service provider, a service reseller, a service broker, or a telecommunications operator. The system may be able to simultaneously support relatively large numbers of receivers and distributors.

The receiver comprises a selector for selecting a distributor of the content from a plurality of distributors. The selector may be implemented e.g. in hardware with, for example, digital circuit logic, or in software with, for example, a routine for sorting or filtering a list of the plurality of distributors or addresses thereof. The receiver may be configured with the plurality of distributors and arranged to obtain the plurality from a source. The receiver may be configured with an address of the source of the plurality. The content may comprise the plurality of distributors, and the receiver may be arranged to extract the plurality from the content received. The receiver may use still other mechanisms to discover the plurality of distributors.

The receiver comprises content-requesting means for requesting the content from the selected distributor, and receiving means for receiving the content. The content-requesting means and the receiving means may each comprise or share an antenna, a tuner, a network adapter, a detector, a channel encoder/decoder, a content encoder/decoder, or a signaling stack. The content request may have a format like a HTTP request, a multicast join, a SIP invite, or another format.

The distributor of the content comprises content request-receiving means for receiving a request for the content, and a dispatcher for dispatching the content. The content request-receiving means and the dispatcher may each comprise or share means mentioned above for the content-requesting means and the receiving means.

The distributor is arranged to dispatch the content to the receiver in response to receiving a request for the content from the receiver. An example of a distributor is a server of a network in accordance with a client-server architecture, e.g. a HTTP server, a CORBA server, a DCOM server, a server offering a web service, a node in a multicast hierarchy, a multicast server, a server implementing an API for invoking remote methods, or a server typically owned by a service provider.

The receiver comprises identity-determining means for determining an identity associated with the content.

The identity has the purpose of uniquely identifying the content. To prevent a change in content received upon selecting a distributor, it is to be avoided that a single identity is additionally associated with another content. To prevent an unnecessary restriction of selectable distributors of the content, it is to be avoided that another identity is additionally associated with the content. Therefore, the identity is ideally associated with the content by a one-to-one mapping. The identity is dependent on the content, but not on e.g. the distributor or on the particularities for addressing the content. This ensures that each alternative distributor of the content may be identified on the basis of identity.

The identity may have the format of e.g. a plain string of bits, an ASCII coded string of digits, a watermark, or another format.

The identity may be obtained in accordance with one of several principles. In e.g. a first principle, the receiver is configured with the identity. This has the advantage that it is relatively simple and offers an immediate availability of the identity at the receiver. In e.g. a second principle, the receiver is configured with a set of identities each associated with a feature of the respective content, and the appropriate identity is selected from the set by examining the content for the respective feature. This has the advantage that the receiver may apply a plurality of identities without the hassle of obtaining the identities from elsewhere. In e.g. a third principle, the receiver obtains the identity by receiving it. This has the advantage that the receiver does not need configured identities. This allows changes in the identities handled over time by the receiver. It may also lessen memory requirements. Since the identities are received, an accumulator for many identities can be dispensed with. In e.g. a fourth principle, the receiver sends a request for the identity and receives the identity in a response. In e.g. a fifth principle, the identity is derived from the content or part of the content. This has the advantage that the identity is rigidly coupled to the content, eliminating some possibilities for mixing up identities and respective contents. An example is to offer the content to an input of a calculator that implements an identity-generating function of the input, e.g. a hash function, or a fingerprint. In e.g. a sixth principle, an identity is obtained from an identity-issuing authority that registers the mapping from content to identity. This has the advantage that the issuing of identities may be subject to enforcement policies. In e.g. a seventh principle, the identity is assigned to the content at the time it is created. The identity may then e.g. depend on the content creation time, the content creator, the content creating application, or credentials of either of these. This has the advantage that the content only exists while being associated with an identity and thus eliminates a cause for unidentifiable content.

The receiver comprises a verifier for verifying an availability of the content at the distributor based on the identity determined. The verifier may perform the verification by matching the identity with e.g. another identity previously obtained. Alternatively, the verifier may forward the identity and delegate the verification to e.g. a distributor. The verifier may comprise a memory for storing particularities of previous verifications, and rely on the contents of the memory for a faster verification.

The receiver is arranged to only select the distributor if the verifier verified the availability of the content at the distributor. This may be achieved with one of several methods. In a first method, a distributor is pre-selected from the plurality, and the availability of the content at the pre-selected distributor is verified by the verifier. The pre-selection may be done by picking a distributor at random. This has the advantage that all distributors have an equal chance to be pre-selected, thus avoiding any bias. Alternatively, the pre-selection may be done by taking a history of selected distributors and their particularities into account, for example, favoring frequently selected distributors, or avoiding pre-selection of a distributor the last reception of which suffered from a relatively bad quality. This has the advantage that a relatively low average number of verifications may suffice for a positive verification.

In a second method, the receiver comprises a memory and stores an inventory of contents available from at least two of the plurality of distributors. To achieve this, the receiver may actively query the distributors for their contents or receive this as part of pushes from the distributors, e.g. service announcements. The information stored in the memory may be processed to obtain a list of alternative distributors for each identity. This has the advantage that an alternative distributor can be found relatively fast by way of a look-up.

The selector may be triggered to select a distributor by an event. Examples of the event are a demand for another content, a drop in a content reception quality, a clock arriving at a chosen relative time, or a change in a condition for the distribution, e.g. a fee to be paid.

The content may be produced at the distributor, or alternatively at a content creator.

A further advantage of the system is that no additional reporting on the connections is required from the receiver, thus saving bandwidth. In the prior-art system, the client wrapper object has to provide information to the monitoring server so as to enable the monitoring server to monitor. This generates traffic that may interfere with the streams carrying the content. In addition, it consumes bandwidth, which is a limited resource.

Another advantage is that the system may also work properly in a situation with at least two completely decoupled networks. In such a case, the system comprises a first network with a first distributor and a second network with a second distributor, and the receiver is part of both the first and the second network. The first network comprises a first communication path between the receiver and the first distributor. Similarly, the second network comprises a second communication path between the receiver and the second distributor. The first and the second network may be mutually completely decoupled, and the first and the second communication path may be mutually exclusive, while the receiver is still capable of verifying availability of a content at both the first and the second distributor.

Advantageously, the receiver comprises a memory for storing the identity. This has the advantage that the identity, once stored, is immediately available at the receiver and thus ensures a relatively fast identification.

The memory may additionally store particularities for requesting and receiving the content from the distributor. Examples of particularities are an address of the distributor to which the request is sent, or e.g. a TCP socket, a UDP socket, or multicast address of where to obtain the content from. This has the advantage that the content may be received relatively fast after selecting the distributor, because the particularities may be retrieved from the memory.

The memory may additionally store identities and particularities pertaining to a further distributor among the plurality of distributors. This has the advantage that the receiver may determine a list with verified alternative distributors for each available content, with the possibility to further reduce the time for selecting a distributor and initiating reception of the content from this distributor.

Advantageously, the receiver stores data on several distributors offering the content, while only presenting, at least as a default, a single occurrence of the content in an interface to an operator of the receiver. This has the advantage that the operator is not disturbed with several instances of the same content.

In an embodiment, the system has the features of claim 2 and, besides the content, the receiver receives the identity. The receiver therefore comprises identity-receiving means. The identity-receiving means and the content-receiving means may have parts in common, for example, an antenna, an input connector, an amplifier, a mixer, a detector, a decoder, a network adapter, or a protocol stack. The receiver is arranged to determine an identity by receiving the identity from one of the plurality of distributors. This has the advantage that the receiver does not need to e.g. compose, construct or calculate the identity, thus saving resources like power, processing capacity and memory. Another advantage is that the receiver does not need to be configured for a particular identity. Since identities received may be disposed of after the verification, another advantage is that the receiver may handle enormous amounts of identities without exhaustive resources like memory. Advantageously, it may be relatively easy to obtain a one-to-one mapping between identity and content, depending on the manner in which identities are distributed. The identity received may be implemented with a so-called push model, where the identity is distributed and received without a request for the identity. This may save required bandwidth for distributing the identities, especially if e.g. only the changes in the identities are communicated by way of the push model.

In another embodiment, the system has the features of claim 3, and the receiver may request the identity from the distributor. The receiver therefore has identity-requesting means and receives the identity after requesting the identity from the distributor. In its turn, the distributor has identity request-receiving means for receiving the request for the identity, and an identity dispatcher for dispatching the identity in response to receiving a request for the identity. This embodiment has the advantage that the receiver is in control of the fact when and from which distributor the identity is requested. This may save bandwidth with respect to the push model, because the identity is only distributed if the receiver needs it. The request for the identity is also an additional check in the sense that the distributor must be reachable or be connected, before requesting the content.

In another embodiment, the system has the features of claim 4, and the receiver may switch distributors. The system therefore comprises a further distributor. The receiver is arranged to receive a further identity from the further distributor. The verifier comprises a comparator for comparing the identity associated with the content with the further identity received. The verifier is arranged to verify the availability of the content at the further distributor if the identity equals the further identity. The receiver is arranged to only select the further distributor if the verifier verified the availability of the content at the distributor. This has the advantage that the receiver may switch between a state of receiving the content from the distributor to a further state of receiving the content from the further distributor. While switching from state to state, the verification ensures that the very same content is available at the distributor that has been switched to. To further enhance this, the switching may be performed in such a way that the content is received without interruptions or hick-ups. Several techniques may be applied to achieve this. In a first technique, the receiver is able to switch to the further distributor just as the content starts to arrive from the further distributor. In a second technique, the receiver receives the content from both the distributor and the further distributor for a relatively short time. During this time, the switching takes place. This technique may be further enhanced by overcoming a time difference between the respective contents. In one example, respective contents are at least partially stored in a buffer so as to take the time difference into account.

In another embodiment, the system has the features of claim 5, and selecting a distributor may be triggered by a change in a quality of receiving the content. The receiver comprises quality-determining means which determine a quality of receiving the content of the distributor, and selects the further distributor in dependence upon the determined quality. This may contribute to a reception with a high quality, because selecting a further distributor is e.g. triggered by the quality dropping below a chosen threshold. The quality may pertain to, for example, a technical property of the reception, e.g. a packet loss rate of packets carrying the content through a packet-based network, a received signal strength of an electromagnetic carrier wave modulated with the content, a measured bit error rate of a stream of bits in a digital channel, or a frame retransmission rate of frames carrying the content. The quality may alternatively pertain to a non-technical property of the reception, e.g. a billing scheme for the content from the distributor, an availability of a resource along the path to the distributor, or a loyalty program for the content from the distributor.

In another embodiment, the system has the features of claim 6, and the identity may be derived from the content. The receiver has identity-deriving means and derives the identity from content received from one of the plurality of distributors. This offers a combination of the above-mentioned advantages of receiving the identity, while adding the advantage that the identity is rigidly coupled to the content until it is derived. An identity that is separate from the associated content or less rigidly coupled bears a higher risk of getting lost or being associated with another content by mistake. The content may contain, for example, the identity as a watermark and the identity-deriving means may extract the watermark from the content.

In another embodiment, the system has the features of claim 7, and the verification may be at least partially delegated to a further distributor comprised by the system. The further distributor comprises verification request-receiving means for receiving a verification request for verifying availability at the further distributor of content associated with a further identity. The further identity is part of the verification request. The further distributor comprises a verification result dispatcher for dispatching a verification result. In response to receiving the verification request from the receiver, the further distributor is arranged to verify availability at the further distributor of content associated with the further identity and to dispatch the verification result to the receiver. The receiver is arranged to only select the further distributor after dispatching a verification request to the further distributor and receiving a verification result that verifies the availability of the content at the further distributor. Since the further distributor is equipped to participate in the verification, this embodiment has the advantage that the receiver does not need to handle or compare multiple identities. This may simplify the complexity of the system, for example, because the system may comprise thousands of receivers, but only a dozen distributors.

The above object and features of the system of the present invention will be more apparent from the following description with reference to the drawing.

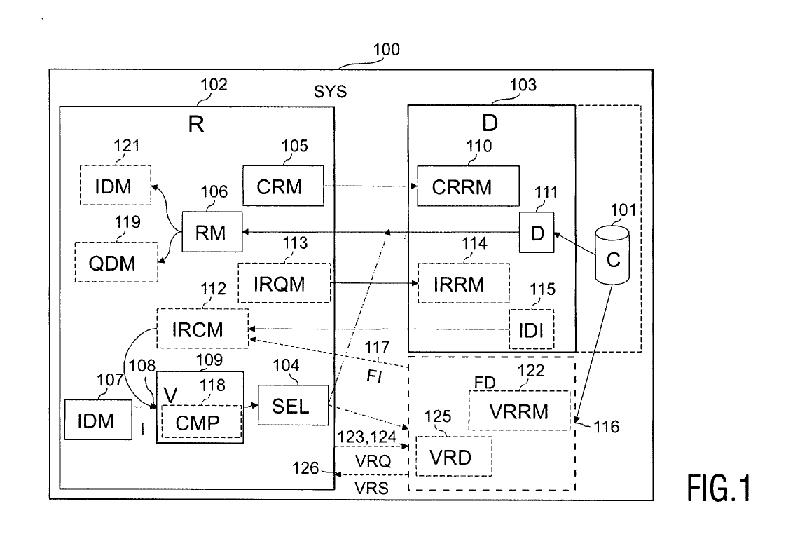

FIG. 1 is a block diagram of a system according to the invention.

In this embodiment, the system 100 comprises a network for distributing a Digital Video Broadcasting (DVB) service 101, as discussed in the Digital Video Broadcasting standardization consortium. The distributor 103 is e.g. a node in a multicast hierarchy, which is typically owned by a service provider 103. In this embodiment, the content 101 is a single Digital Video Broadcasting service 101, but in general it may also be a multiplex of such DVB services, or a bouquet. The receiver 102 is a so-called Home Network End Device (HNED). The HNED may be, for example, a set-top box, an Internet television product, an Internet Radio or a PC equipped with a terminal adapter. The HNED typically comprises software for obtaining the content 101 from the received signals.

In the following description, the terms DVB service 101, service provider 103, and HNED 102 are used and refer to the terms content 101, distributor 103, and receiver 102, respectively.

Each DVB service 101 is associated with an identity 108 with a one-to-one mapping. The identity 108 may therefore serve to verify that another instance of a DVB service 101 offered by a further service provider 116 is indeed the same DVB service 101 as the instance of the selected service provider 103. Based on the identity 108, the HNED may be arranged to present each DVB service 101 only once to the user via the user interface. This prevents the user from being disturbed with multiple instances of the same DVB service 101. New DVB services may be announced with a service announcement. The service announcement may comprise respective identities of the new DVB services. The service announcements may be provided to the HNED via a regular multicast—the push model—or via a HNED—initiated request—the pull model. The receiver 102 may comprise a memory for storing data pertaining to receiving DVB services, for example, identities of available content 101, multicast addresses, IP addresses, and a history of a quality of the reception. In response to receiving a service announcement, the receiver 102 may update the data stored in the memory.

Multiple service providers 103 may simultaneously offer a single DVB service 101 to a user, resulting in multiple instances of the DVB service 101. The DVB service 101 may be offered via a single access network connection or via various access network connections. The network/traffic parameters, the quality of the service and the cost of the service generally differ between the various service providers 103.

It may be expected that a HNED stores only the information pertaining to one of the available instances of a DVB service 101, because this saves the memory from storing the particulars of the other instances of the same DVB service 101, and because this suffices for initiating a reception of the DVB service 101. However, in general, the availability of a DVB service 101 cannot be guaranteed, because the ‘state’ of a network connection is not stable with respect to, for instance, an available bandwidth, a delay, a jitter, or a cost of the connection. If the HNED only stores the information of one instance, a user of the HNED may notice a disrupted reception, an incomplete service 101 or even a black screen if the DVB service 101 cannot be delivered by the current service provider 103 anymore. This may last until the HNED receives an update of the available DVB services.

In a HNED in accordance with the invention, the HNED may also store information of a further instance of the DVB service 101 available at a further distributor 116. As a default, the HNED may present only a single instance to the operator of the HNED. By storing the relevant information from at least another instance of a service 101 in the HNED, the HNED is able to select a further instance based on a criterion. The criterion could be dependent on the user profile. It is especially useful that, when the connection is lost to the currently selected provider that provides the service 101, the HNED can quickly select another provider on the basis of the stored information about a further instance of the same service 101. A relatively fast selection is possible if the information is stored in the HNED. In such a case, there is no need to gather the information, which may involve waiting for a new multicast message with the information for the push model, or requesting the information from a server for the pull model.

The receiver 102 may be an Internet-enabled radio set, for example, a Philips Streamium. This particular receiver 102 may contact a default aggregator service provider 103, e.g. the Philips PIAP-platform, to get a list of radio channels. However, the receiver 102 may also contact another aggregator service provider 103 or a further service provider 116, to receive a further list of radio channels. Content available from the PIAP-platform may also be available from other service providers 103.

In an example scenario, the user is listening to a radio channel dubbed Radio-1, which is streamed from the PIAP-platform but is also announced by a further service provider 116. The receiver 102 stores the information of both service providers 103 with respect to Radio-1. At a certain moment, a problem may occur in the network between the PIAP-platform and the receiver 102, causing Radio-1 to be no longer received from the PIAP-platform. At the moment the connection goes down, the receiver 102 may set up a connection to the further service provider 116 and the reception of Radio-1 continues. This is possible if the information from the further service provider 116 is already stored in the HNED. The receiver 102 may be arranged to perform the fail-over to the further service provider 116 without requiring user intervention.

In a prior-art system, however, a prior-art receiver would remove the failing channel from the list of channels. The user then typically selects another channel for listening. Some time later, probably of the order of minutes, the Radio-1 channel would typically come back in the list, possibly via a push or a pull from a further service provider.

In the above scenario, selection of the service provider 103 is triggered by the channel being no longer received from the PIAP-platform. However, the receiver 102 could also be triggered to select by changes in the information of the various service 101 parameters.

The same service 101 may be offered from several locations at the same time. The identity 108 suffices to determine service instances of the same service 101 as long as the identity 108 is unique among all services offered by the plurality of distributors.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The invention can be implemented by means of hardware comprising several distinct elements, and by means of a suitably programmed computer. In a system or a device claim that enumerates several means, several of these means can be embodied by the same item of hardware. The mere fact that certain measures are recited in mutually different dependent claims does not indicate that a combination of these measures cannot be used to advantage.

A ‘computer program’ is to be understood to mean any software product stored on a computer-readable medium, such as a floppy disk, downloadable via a network, such as the Internet, or marketable in any other manner.

1. A system (100) for distributing a content (101), the system comprising:
a receiver (102) for receiving the content (101), the receiver comprising:
a selector (104) for selecting a distributor (103) of the content (101) out of a plurality of distributors;
content-requesting means (105) for requesting the content (101) from the distributor (103) selected;
receiving means (106) for receiving the content (101);
identity-determining means (107) for determining an identity (108) associated with the content (101); and
a verifier (109) for verifying an availability of the content (101) at the distributor (103) based on the identity (108) determined,
the distributor (103) of the content (101), comprising:
content request-receiving means (110) for receiving a request for the content (101); and
a dispatcher (111) for dispatching the content (101),
wherein the distributor (103) is arranged to dispatch the content (101) to the receiver (102) in response to receiving a request for the content (101) from the receiver (102), and wherein the receiver (102) is arranged to only select the distributor (103) if the verifier (109) verified the availability of the content (101 ) at the distributor (103).

2. A system (100) as claimed in claim 1, wherein the receiver (102) comprises identity-receiving means (112) and wherein the receiver (102) is arranged to determine an identity (108) by receiving the identity (108) from one out of the plurality of distributors.

3. A system (100) as claimed in claim 2, wherein the receiver (102) comprises identity-requesting means (113), wherein the receiver (102) is arranged to receive the identity (108) after requesting the identity (108) of the content (101 ) from the distributor (103), wherein the distributor (103) comprises:
identity request-receiving means (114) for receiving a request for the identity (108) of the content (101);
an identity dispatcher (115) for dispatching the identity (108), and wherein the distributor (103) is arranged to dispatch the identity (108) to the receiver (102) in response to receiving a request for the identity (108) of the content (101) from the receiver (102).

4. A system (100) as claimed in claim 2, wherein the system (100) comprises a further distributor (116), wherein the receiver (102) is arranged to receive a further identity (124) from the further distributor (116), wherein the verifier (109) comprises a comparator (118) for comparing the identity (108) associated with the content (101) with the further identity (124) received, wherein the verifier (109) is arranged to verify the availability of the content (101) at the further distributor (116) if the identity (108) equals the further identity (124), and wherein the receiver (102) is arranged to only select the further distributor (116) if the verifier (109) verified the availability of the content (101) at the further distributor (116).

5. A system (100) as claimed in claim 4, wherein the receiver (102) comprises quality-determining means (119) for determining a quality of receiving the content (101) of the distributor (103), and wherein the receiver (102) is arranged to select the further distributor (116) in dependence upon the quality determined.

6. A system (100) as claimed in claim 2, wherein the receiver (102) comprises identity-deriving means (121), and wherein the receiver (102) is arranged to derive the identity (108) from content (101) received from one out of the plurality of distributors.

7. A system (100) as claimed in claim 2, wherein the system (100) comprises a further distributor (116), wherein the further distributor (116) comprises:
verification request-receiving means (122) for receiving a verification request (123) for verifying availability at the further distributor (116) of content (101) associated with a further identity (124), the further identity (124) being part of the verification request (123); and
a verification result dispatcher (125) for dispatching a verification result (126), wherein the further distributor (116) is arranged to, in response to receiving the verification request (123) from the receiver (102), the further distributor (116) is arranged to verify availability at the further distributor (116) of content (101) associated with the further identity (124) and to dispatch the verification result (126) to the receiver (102), and wherein the receiver (102) is arranged to only select the further distributor (116) after dispatching a verification request (123) to the further distributor (116) and receiving a verification result (126) that verifies the availability of the content (101) at the further distributor (116).

8. A receiver (102) for receiving a content (101), comprising:
a selector (104) for selecting a distributor (103) of the content (101) out of a plurality of distributors;
content-requesting means (105) for requesting the content (101) from the distributor (103) selected;
receiving means (106) for receiving the content (101);
identity-determining means (107) for determining an identity (108) associated with the content (101); and
a verifier (109) for verifying an availability of the content (101) at the distributor (103) based on the identity (108) determined, and wherein the receiver (102) is arranged to only select the distributor (103) if the verifier (109) verified the availability of the content (101) at the distributor (103).

9. A method of distributing a content (101), comprising the steps of:
selecting a distributor (103) of the content (101) out of a plurality of distributors,
requesting the content (101) from the distributor (103) selected,
dispatching the content (101) to the receiver (102) in response to receiving the request for the content (101) from the receiver (102),
receiving the content (101) at the receiver (102),
determining an identity (108) associated with the content (101), and
verifying an availability of the content (101) at the distributor (103) based on the identity (108) determined,
and wherein, in the step of selecting, the distributor (103) is only selected if the verifier (109) verified the availability of the content (101) at the distributor (103).

10. A computer program product enabling a receiver (102) that is part of a system (100) for distributing a content (101) to select a distributor (103) of the content (101) out of a plurality of distributors, to request and receive the content (101) from the distributor (103) selected, to determine an identity (108) associated with the content (101), to verify an availability of the content (101) at the distributor (103) based on the identity (108) determined, and to only select the distributor (103) after verifying the availability of the content (101) at the distributor (103).
